(19) United States
(12) Patent Application Publication
(10) Pub. No.: US 2022/0299649 A1
(43) Pub. Date: Sep. 22, 2022

(54) OBJECT DETECTION FOR A ROTATIONAL SENSOR

(71) Applicant: QUALCOMM Incorporated, San Diego, CA (US)

(72) Inventors: Manoj Bhat, Pittsburgh, PA (US); Shizhong Steve Han, San Diego, CA (US); Fatih Murat Porikli, San Diego, CA (US)

(21) Appl. No.: 17/249,967

(22) Filed: Mar. 19, 2021

(51) Int. Cl. G01S 17/931; G01S 7/481; G01S 7/48; G01S 17/06

(52) U.S. Cl. CPC G01S 17/931; G01S 7/4817; G01S 7/4808; G01S 17/06

(57) ABSTRACT

In some aspects, a device may obtain point data from a lidar scanner. The point data may be associated with an angular subrange of a polar grid of the lidar scanner. The device may cause a transformer model to process the point data to identify a set of points based at least in part on the angular subrange, analyze the set of points based at least in part on a polar distance between the set of points and an origin of the polar grid, and indicate whether the set of points is associated with an object. The device may perform an action based at least in part on whether the transformer model indicates that the set of points is associated with the object. Numerous other aspects are described.

### FIELD OF THE DISCLOSURE

Aspects of the present disclosure generally relate to rotational sensors and, for example, to object detection for a rotational sensor.

### BACKGROUND

A light detection and ranging (referred to herein as “lidar”) scanner is a rotational sensor that uses light in the form of a pulsed laser to obtain point data indicating an amount of time the light takes to return to the lidar scanner.

### SUMMARY

In some aspects, a method includes obtaining, by a device, point data from a lidar scanner, wherein the point data is associated with an angular subrange of a polar grid of the lidar scanner; causing, by the device, a transformer model to: process the point data to identify a set of points based at least in part on the angular subrange, analyze the set of points based at least in part on a polar distance between the set of points and an origin of the polar grid, and indicate whether the set of points is associated with an object; and performing, by the device, an action based at least in part on whether the transformer model indicates that the set of points is associated with the object.

In some aspects, a device includes one or more memories; and one or more processors, communicatively coupled to the one or more memories, configured to: obtain point data from a lidar scanner, wherein the point data is associated with an angular subrange of a polar grid of the lidar scanner; cause a transformer model to: process the point data to identify a set of points based at least in part on the angular subrange, analyze the set of points based at least in part on a polar distance between the set of points and an origin of the polar grid, and indicate whether the set of points is associated with an object; and perform an action based at least in part on whether the transformer model indicates that the set of points is associated with the object.

In some aspects, a non-transitory computer-readable medium storing a set of instructions includes one or more instructions that, when executed by one or more processors of a device, cause the device to: obtain point data from a lidar scanner, wherein the point data is associated with an angular subrange of a polar grid of the lidar scanner; cause a transformer model to: process the point data to identify a set of points based at least in part on the angular subrange, analyze the set of points based at least in part on a polar distance between the set of points and an origin of the polar grid, and indicate whether the set of points is associated with an object; and perform an action based at least in part on whether the transformer model indicates that the set of points is associated with the object.

In some aspects, an apparatus includes means for obtaining point data from a lidar scanner, wherein the point data is associated with an angular subrange of a polar grid of the lidar scanner; means for causing a transformer model to: process the point data to identify a set of points based at least in part on the angular subrange, analyze the set of points based at least in part on a polar distance between the set of points and an origin of the polar grid, and indicate whether the set of points is associated with an object; and means for performing an action based at least in part on whether the transformer model indicates that the set of points is associated with the object.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which object detection for a rotational sensor described herein may be implemented, in accordance with the present disclosure.

FIG. 2 is a diagram illustrating example components of one or more devices shown in FIG. 1, such as a vehicle and a wireless communication device, in accordance with the present disclosure.

FIGS. 3, 4A, and 4B are diagrams illustrating examples associated with object detection for a rotational sensor, in accordance with the present disclosure.

FIG. 5 is a flowchart of example processes associated with object detection for a rotational sensor, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Point data obtained by a rotational sensor, such as a light detection and ranging (lidar) scanner, may be used for three-dimensional (3D) object detection. The lidar scanner may use light in the form of a pulsed laser to obtain point data as the lidar scanner is rotated. The point data may correspond to a reflection of the light off of an object. The point data associated with an object may include a set of data points indicating an amount of time the light takes to return to the lidar scanner, a direction of the object with respect to the lidar scanner, a distance at which the object is from the lidar scanner, and/or the like. The lidar scanner may obtain a complete point cloud of point data based on a 360 degree rotation of the lidar scanner.

A neural network may be configured to interpret lidar point data to identify objects within range of the lidar scanner. The neural network may analyze a complete point cloud of point data and may identify objects within the environment based at least in part on interpreting the analysis of the point data. However, a same object may generate different point data based at least in part on the distance between the lidar scanner and the object (e.g., a vehicle at ten meters may cause the lidar scanner to generate different point data than point data generated for a vehicle at fifty meters). Furthermore, the complete point cloud of data involves a relatively large quantity of data that needs to be processed before an object is detected, and the neural network may require a relatively large amount of processing resources to analyze the large quantity of data.

Further, as the range increases from the lidar scanner, the point data obtained by the lidar scanner becomes sparser and, commonly, relatively few points of point data are obtained beyond a distance of eighty meters relative to a quantity of points of point data obtained at closer distances. The relatively few points of point data obtained beyond eighty meters may prevent the neural network from detecting key features of an object.

Some implementations described herein relate to object detection for a rotational sensor. For example, a lidar system may obtain point data from a lidar scanner. The point data may be associated with an angular subrange of a polar grid associated with the lidar scanner. The lidar system cause a transformer model to process the point data to identify a set of points based at least in part on the angular subrange, analyze the set of points based at least in part on a polar distance between the set of points and an origin of the polar grid, and indicate whether the set of points is associated with an object. The lidar system may perform an action based at least in part on whether the transformer model indicates that the set of points is associated with the object.

In this way, the lidar system utilizes a transformer model (with a trained encoder and decoder) to detect a particular type of object based at least in part on distances between the point data associated with the object and the lidar scanner. Accordingly, the encoder may translate the point data differently according to the position of the object relative to the lidar scanner. Further, by detecting an object based on point data associated with an angular subrange of a polar grid of the lidar scanner, the lidar system may conserve computing resources (e.g., processing resources, memory resources, and/or communications resources) relative to systems configured to detect an object based on an entire range (e.g., 360 degrees) of a polar grid.

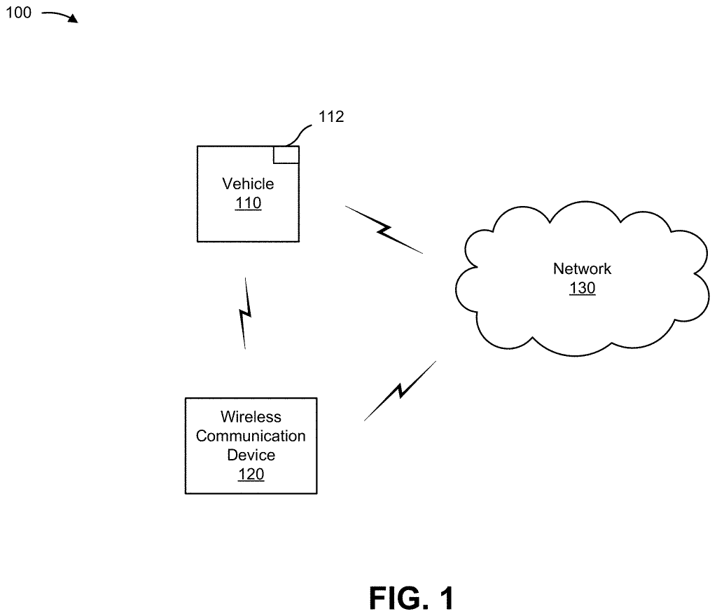

FIG. 1 is a diagram of an example environment 100 in which systems and/or methods described herein may be implemented. As shown in FIG. 1, environment 100 may include a vehicle 110 with a corresponding electronic control unit (ECU) 112, a wireless communication device 120, and a network 130. Although vehicle 110 is shown in FIG. 1 with a single corresponding ECU 112 (e.g., the ECU 112 is collocated with the vehicle 110), the vehicle 110 in environment 100 may include two or more ECUs 112. Devices of environment 100 may interconnect via wired connections, wireless connections, or a combination of wired and wireless connections.

The vehicle 110 may include any vehicle that is capable of transmitting and/or receiving data associated with object detection for a rotational sensor, as described herein. For example, the vehicle 110 may be a consumer vehicle, an industrial vehicle, a commercial vehicle, and/or the like. The vehicle 110 may be capable of traveling and/or providing transportation via public roadways, may be capable of use in operations associated with a worksite (e.g., a construction site), and/or the like. The vehicle 110 may include a sensor system that includes one or more sensors that are used to generate and/or provide vehicle data associated with vehicle 110 and/or a lidar scanner that is used to obtain point data used for 3D object detection.

The vehicle 110 may be controlled by the ECU 112, which may include one or more devices capable of receiving, generating, storing, processing, and/or providing information associated with object detection for a rotational sensor described herein. For example, the ECU 112 may include and/or be a component of a communication and/or computing device, such as, an onboard computer, a control console, an operator station, or a similar type of device. The ECU 112 may be configured to communicate with other ECUs and/or other devices. For example, advances in communication technologies have enabled vehicle-to-everything (V2X) communication, which may include vehicle-to-vehicle (V2V) communication, vehicle-to-pedestrian (V2P) communication, and/or the like. In some aspects, the ECU 112 may include and/or be used to provide V2X communication, vehicle data associated with the vehicle 110 (e.g., identification information, sensor data, and/or the like), as described herein.

The wireless communication device 120 includes one or more devices capable of receiving, generating, storing, processing, and/or providing information associated with object detection for a rotational sensor, as described elsewhere herein. For example, the wireless communication device 120 may include a base station, an access point, and/or the like. Additionally, or alternatively, the wireless communication device 120 may include a communication and/or computing device, such as a mobile phone (e.g., a smart phone, a radiotelephone, and/or the like), a laptop computer, a tablet computer, a handheld computer, a desktop computer, a gaming device, a wearable communication device (e.g., a smart wristwatch, a pair of smart eyeglasses, and/or the like), or a similar type of device.

The network 130 includes one or more wired and/or wireless networks. For example, the network 130 may include a peer-to-peer (P2P) network, a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. In some aspects, the network 130 may include and/or be a P2P communication link that is directly between one or more of the devices of environment 100.

The number and arrangement of devices and networks shown in FIG. 1 are provided as one or more examples. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

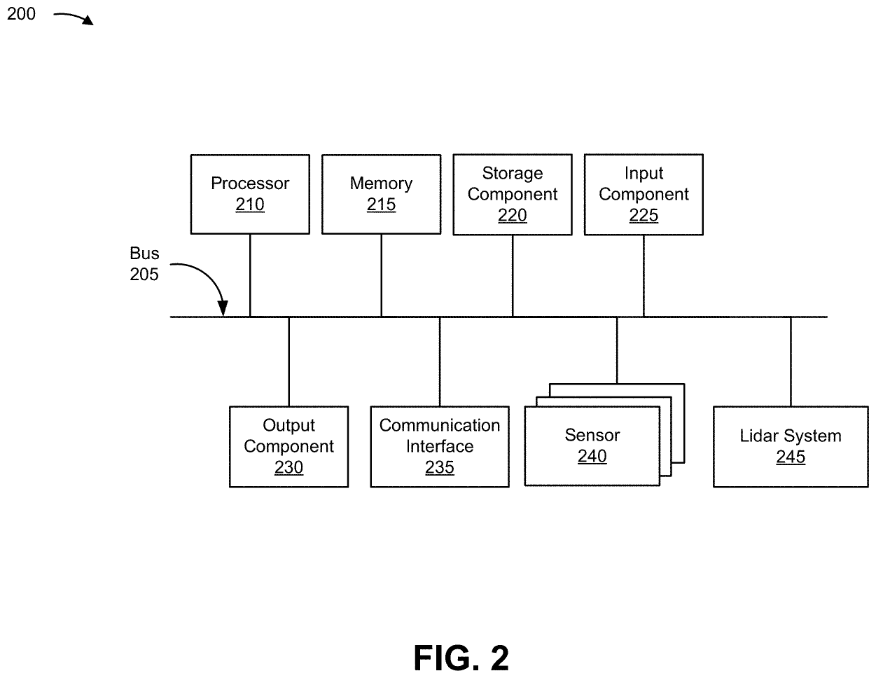

FIG. 2 is a diagram illustrating example components of a device 200, in accordance with the present disclosure. The device 200 may correspond to the vehicle 110, the ECU 112, and/or the wireless communication device 120. In some aspects, the vehicle 110, the ECU 112, and/or the wireless communication device 120 may include one or more devices 200 and/or one or more components of the device 200. As shown in FIG. 2, device 200 may include a bus 205, a processor 210, a memory 215, a storage component 220, an input component 225, an output component 230, a communication interface 235, a sensor 240, a lidar system 245, and/or the like.

The bus 205 includes a component that permits communication among the components of device 200. The processor 210 is implemented in hardware, firmware, software, or a combination of hardware, firmware, and software. The processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, the processor 210 includes one or more processors capable of being programmed to perform a function. The memory 215 includes a random access memory (RAM), a read only memory (ROM), and/or another type of dynamic or static storage device (e.g., a flash memory, a magnetic memory, and/or an optical memory) that stores information and/or instructions for use by the processor 210.

The storage component 220 stores information and/or software related to the operation and use of device 200. For example, the storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 225 includes a component that permits device 200 to receive information, such as via user input (e.g., a touch screen display, a keyboard, a keypad, a mouse, a button, a switch, and/or a microphone). Additionally, or alternatively, the input component 225 may include a component for determining a position or a location of the device 200 (e.g., a global positioning system (GPS) component, a global navigation satellite system (GNSS) component, and/or the like) a sensor for sensing information (e.g., an accelerometer, a gyroscope, an actuator, another type of position or environment sensor, and/or the like)). The output component 230 includes a component that provides output information from the device 200 (e.g., a display, a speaker, a haptic feedback component, an audio or visual indicator, and/or the like).

The communication interface 235 includes a transceiver-like component (e.g., a transceiver and/or a separate receiver and transmitter) that enables the device 200 to communicate with other devices, such as via a wired connection, a wireless connection, or a combination of wired and wireless connections. The communication interface 235 may permit the device 200 to receive information from another device and/or provide information to another device. For example, the communication interface 235 may include an Ethernet interface, an optical interface, a coaxial interface, an infrared interface, a radio frequency interface, a universal serial bus (USB) interface, a wireless local area interface (e.g., a Wi-Fi interface), a cellular network interface, and/or the like.

The sensor 240 includes one or more devices capable of sensing characteristics associated with device the 200. The sensor 240 may include one or more integrated circuits (e.g., on a packaged silicon die) and/or one or more passive components of one or more flex circuits to enable communication with one or more components of the device 200.

The sensor 240 may include an optical sensor that has a field of view in which the sensor 240 may determine one or more characteristics of an environment of the device 200. In some aspects, the sensor 240 may include a camera. For example, the sensor 240 may include a low-resolution camera (e.g., a video graphics array (VGA)) that is capable of capturing images that are less than one megapixel, images that are less than 1216×912 pixels, and/or the like. The sensor 240 may be a low-power device (e.g., a device that consumes less than ten milliwatts (mW) of power) that has always-on capability while the device 200 is powered on.

Additionally, or alternatively, the sensor 240 may include magnetometer (e.g., a Hall effect sensor, an anisotropic magneto-resistive (AMR) sensor, a giant magneto-resistive sensor (GMR), and/or the like), a location sensor (e. g., a global positioning system (GPS) receiver, a local positioning system (LPS) device (e. g, that uses triangulation, multi-lateration, and/or the like), and/or the like), a gyroscope (e.g., a micro-electro-mechanical systems (MEEMS) gyroscope or a similar type of device), an accelerometer, a speed sensor, a motion sensor, an infrared sensor, a temperature sensor, a pressure sensor, and/or the like.

The lidar system 245 may include a lidar scanner that uses light in the form of a pulsed laser to measure distances of objects from the lidar scanner. The lidar system 245 may utilize data obtained by the lidar scanner to perform 3D object detection, as described herein.

The device 200 may perform one or more processes described herein. The device 200 may perform these processes based on the processor 210 executing software instructions stored by a non-transitory computer-readable medium, such as the memory 215 and/or the storage component 220. A computer-readable medium is defined herein as a non-transitory memory device. A memory device includes memory space within a single physical storage device or memory space spread across multiple physical storage devices.

Software instructions may be read into the memory 215 and/or the storage component 220 from another computer-readable medium or from another device via the communication interface 235. When executed, software instructions stored in the memory 215 and/or the storage component 220 may cause the processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, the device 200 includes means for performing one or more processes described herein and/or means for performing one or more operations of the processes described herein. For example, the device 200 may include means for obtaining point data from a lidar scanner. The point data may be associated with an angular subrange of a polar grid of the lidar scanner. The device 200 may include means for causing a transformer model to process the point data to identify a set of points based at least in part on the angular subrange, analyze the set of points based at least in part on a polar distance between the set of points and an origin of the polar grid, and indicate whether the set of points is associated with an object. The device 200 may include means for performing an action based at least in part on whether the transformer model indicates that the set of points is associated with the object. In some aspects, such means may include one or more components of the device 200 described in connection with FIG. 2, such as the bus 205, the processor 210, the memory 215, the storage component 220, the input component 225, the output component 230, the communication interface 235, the sensor 240, the lidar system 245, and/or the like.

The number and arrangement of components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

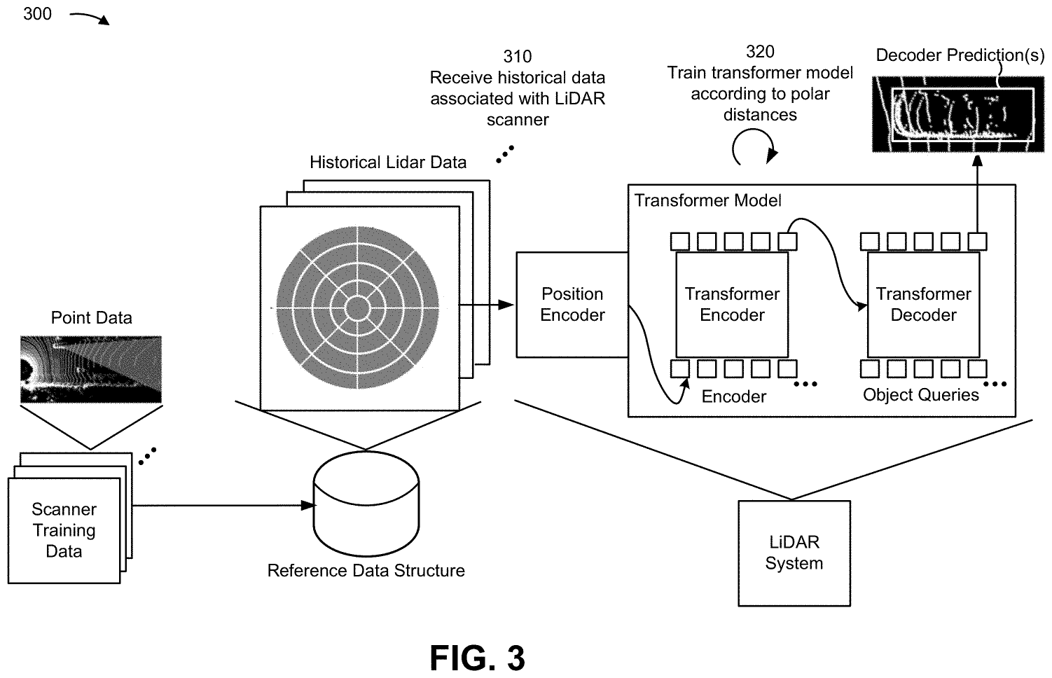

FIG. 3 is a diagram illustrating an example 300 associated with object detection for rotational sensors, in accordance with the present disclosure. As shown in FIG. 3, example 300 includes a lidar system configured to generate and/or train a transformer model to perform object detection based on lidar scanner training data.

As shown by reference number 310, the lidar system receives historical data associated with a lidar scanner. The historical data may include one or more complete point clouds of data points generated by a lidar scanner, generated by a machine learning model, input by a user, and/or the like. For example, the historical data may include one or more complete point cloud of data points associated with one or more types of objects (e.g., vehicles, roadside objects, people, and/or animals, among other examples), located at one or more distances from the lidar scanner, that the transformer model is to be trained to detect. The historical data may be stored in a reference data structure associated with the lidar system and/or another device (e.g., a third-party server device). The lidar system may receive the historical data from the reference data structure and may provide a complete point cloud of data points, associated with an object and included in the historical data, to a position encoder associated with the lidar system.

In some aspects, the historical data includes a set of ground truth objects indicating an actual position of objects represented by the complete point cloud of data points. A ground truth object may include a set of parameters of an oriented 3D bounding box. For example, a ground truth object may include a first parameter indicating an x-axis Cartesian coordinate, a second parameter indicating a y-axis Cartesian coordinate, a third parameter indicating a z-axis Cartesian coordinate, a fourth parameter indicating a width of the bounding box, a fifth parameter indicating a length of the bounding box, a sixth parameter indicating a height of the bounding box, a seventh parameter indicating a sine of a heading angle of the bounding box, an eighth parameter indicating a cosine of the heading angle of the bounding box, and a ninth parameter indicating a class associated with the bounding box.

The position encoder may receive the complete point cloud of data points and may translate the historical data to a polar grid. The origin of the polar grid may correspond to a location of a lidar scanner associated with the complete point cloud of data points (e.g., a lidar scanner used to obtain the complete point cloud of data points). The polar grid may be divided into a plurality of angular subranges extending from the origin. For example, the polar grid may be divided into four angular subranges of ninety degrees, eight angular subranges of forty-five degrees, and/or the like. Additionally, the polar grid may be divided into a series of concentric circles centered on the origin of the polar grid. For example, the polar grid may be divided into a series of three, four, five, six, and/or the like concentric circles. In some aspects, the quantity of concentric circles is determined based on a size of a geographical area represented by the polar grid and/or associated with the complete point cloud of data points. In some aspects, the radii of the concentric circles may be multiples of a smallest radius of a first concentric circle. For example, a radius of the first of the concentric circle may be a first value X and the radius of a second concentric circle may be twice the first value (e.g., 2×).

The concentric circles may intersect the angular ranges to define rings of polar cells. Each ring of polar cells may include a polar cell within each angular range. For example, the polar grid may be divided into eight angular subranges and five concentric circles to define a total forty polar cells of five different sizes (e.g., five rings of polar cells). The position encoder may translate a position of a data point included in the complete point cloud of data points to a position on the polar grid. The position encoder may associate the data point with information identifying the position of the data point on the polar grid (e.g., a set of polar coordinates). The position encoder may determine an angular subrange and/or a polar cell that includes the position of the data point on the polar grid and may associate the data point with information identifying the angular subrange and/or the polar cell.

In some aspects, the position encoder may determine that an object extends across multiple polar cells based on translating the historical data to the polar grid. The position encoder may identify a polar cell that includes a greatest portion of the object, a threshold percentage (e.g., 40%, 45%, 50%, and/or the like) of the object, and/or the like and may associate data points associated with the object with information identifying the polar cell.

As shown by reference number 320, the lidar system trains the transformer model according to polar distances. The transformer model may include an encoder and a decoder. The encoder may identify an angular subrange associated with a plurality of polar cells. The encoder may identify a polar cell, of the plurality of polar cells and may obtain a set of data points associated with the polar cell. The encoder may translate polar coordinates associated with the set of data points to object query data. The object query data may comprise three-dimensional data that is associated with a type of object that the transformer model is trained to detect and/or identify.

The decoder may predict whether the set of data points is associated with the type of object based at least in part on the object query data. The decoder may be configured to predict whether the set of data points is associated with the type of object based at least in part on a similarity analysis associated with the object query data and reference data associated with a type of the object.

In some aspects, the prediction generated by the decoder includes information indicating that an object is detected and information indicating a type of the detected object. For example, the decoder may generate an output that includes information identifying a bounding box associated with a detected object and/information identifying a type of the detected object.

The transformer model may utilize the encoder and/or the decoder to find a bipartite matching between a prediction generated based on a set of data points and a ground truth object. The transformer model may search for a permutation of N elements (where N is the quantity of predictions) with the lowest cost. In some aspects, the transformer utilizes an algorithm (e.g., the Hungarian algorithm) to compute an optimal matching based on a pair-wise matching cost between ground truths and predictions associated with the ground truths.

In some aspects, prior to translating the historical data to the polar grid, the lidar system may produce a global feature extraction layer that extracts features of objects represented by the complete point cloud of data points directly from the Cartesian space associated with the complete point cloud of data points to generate an extracted pseudo-image. The extracted pseudo-image may be discretized into the polar space of ring-sector combinations of polar cells. A bounding box of a first size is calculated to be the same for all of the polar cells included in a ring. A convolutional neural network (CNN) may transform features associated with bounding boxes calculated for each ring into one or more embedding shapes. In some aspects, the transformer model may utilize a different CNN for each ring of polar cells.

In some aspects, the historical data includes sets of data points representative of an object at various distances. The transformer model may be trained to determine whether the set of data points included in the first polar cell is representative of the object based at least in part on the sets of data points representative of the object at various distances. In this way, the transformer model may be trained to detect the object at various distances from the lidar scanner.

In some aspects, the historical data includes a set of data points associated with another lidar scanner that identified a first object in an area that is a physical distance from the another lidar scanner and the transformer model is trained to determine whether the set of data points included in the first polar cell is representative of a second object that is the physical distance from the lidar scanner based at least in part on the set of points associated with the other lidar scanner. In this way, the transformer model is trained to detect objects based on a distance the object is from the lidar scanner. The lidar scanner and the other lidar scanner may be the same lidar scanner or different lidar scanners. The first object and the second object may be a same type of object (e.g., a same type of vehicle, a person, an animal, a roadside object, and/or the like).

In some aspects, the transformer model is trained to determine whether the set of points is representative of the second object based at least in part on historical data associated with the first object within a feature space that corresponds to a polar cell, of the polar grid, that is defined by a polar distance corresponding to the physical distance.

In some aspects, the transformer model is trained to determine whether the set of points is representative of the second object based at least in part on an arrangement of the set of points within a polar cell of the polar grid. The transformer model may be trained based at least in part on historical sets of points associated with the first object within a feature space that corresponds to the polar cell.

As indicated above, FIG. 3 is provided as an example. Other examples may differ from what is described with respect to FIG. 3.

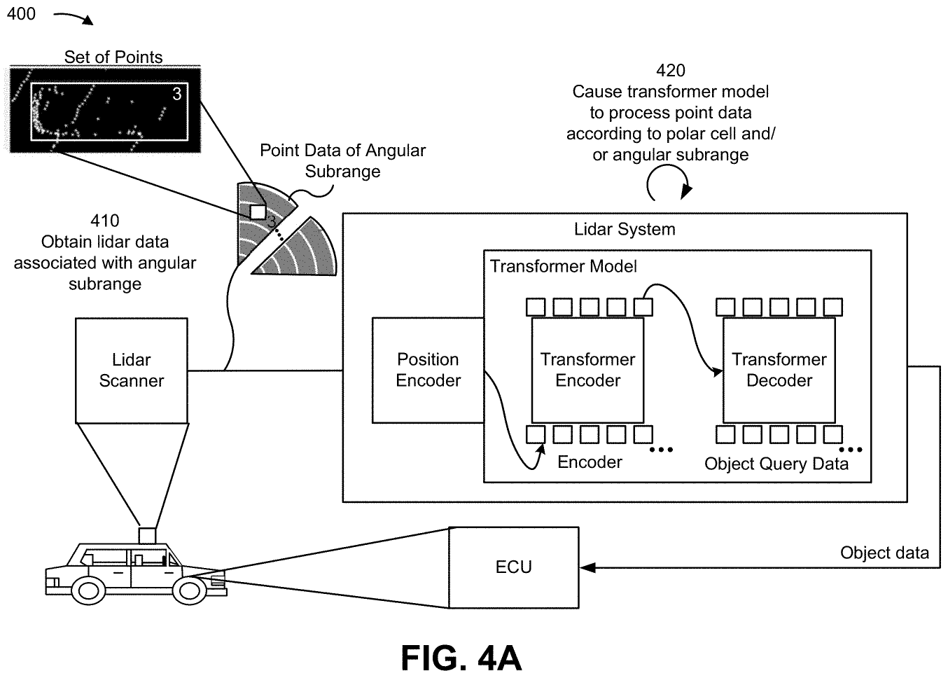

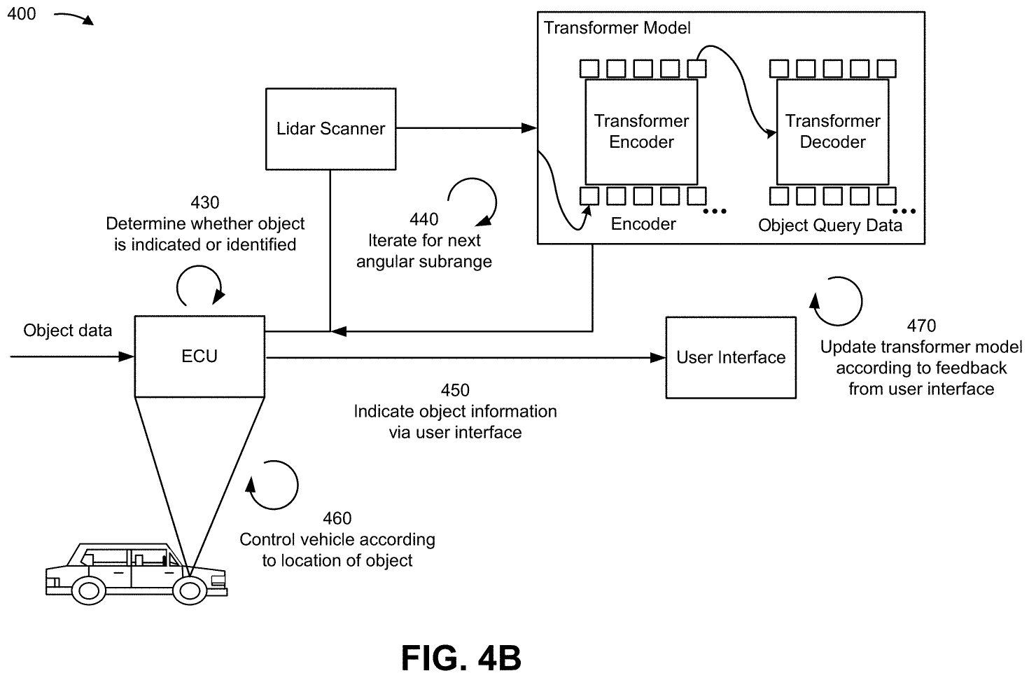

FIGS. 4A-4B are diagrams illustrating an example 400 associated with object detection for rotational sensors, in accordance with the present disclosure. As shown in FIGS. 4A-4B, example 400 includes a lidar system to perform object detection based on lidar data received from a lidar scanner associated with a vehicle.

As shown in FIG. 4A, and by reference number 410, the lidar scanner obtains lidar data (e.g., sets of point data) associated with an angular subrange of a polar grid. An origin of the polar grid may correspond to a location of the lidar scanner. The angular subrange of the polar grid may correspond to a range that is a threshold percentage (e.g., 10%, 12.5%, 20%, 25%, and/or the like) of 360 degrees.

In some aspects, the lidar scanner provides the lidar data associated with the angular subrange to the lidar system based on obtaining the lidar data (e.g., prior to the lidar scanner obtaining a complete point cloud of lidar data). Alternatively, and/or additionally, the lidar scanner may provide the complete point cloud of lidar data to the lidar system and the lidar system may sequentially process sets of points based on an angular subrange and/or a polar cell associated with the sets of points.

The lidar system may provide the lidar data to the position encoder based on receiving the lidar data from the lidar scanner. The position encoder may translate the lidar data to a polar grid having an origin corresponding to a location of the lidar scanner. The polar grid may be divided into a plurality of angular subranges and a plurality of concentric circles to define a plurality of rings of polar cells in a manner similar to that described above with respect to FIG. 3. For a data point included in the lidar data, the position encoder may determine a set of polar coordinates for the data point based on a distance and a direction of the data point from the location of the lidar scanner. The encoder system may determine an angular subrange and/or a polar cell associated with the data point based on the set of polar coordinates.

As shown by reference number 420, the lidar system causes the transformer model to process point data according to a polar cell and/or the angular subrange. The transformer model may process the point data based at least in part on a sequence associated with the polar grid. The sequence may indicate an order in which individual subsets of point data that are associated with corresponding polar cells of the polar grid are to be processed. In some aspects, the sequence indicates that the individual subsets of the point data are to be processed based on a distance the corresponding polar cells are from the origin of the polar grid. For example, a set of point data associated with a first polar cell that is closer to the origin relative to a second polar cell is processed prior to a set of point data associated with the second polar cell.

The transformer model may identify a first polar cell based on the sequence. The transformer model may identify a set of data points associated with the first polar cell. The transformer model may process a set of point data associated with the set of data points based on the set of data points being associated with the first polar cell. The transformer model may generate an output based on processing the set of point data. The output may include object data indicating whether the set of point data is associated with an object and/or a type of object associated with the set of point data.

In some aspects, the transformer model may generate the output based on processing the set of point data. In some aspects, the transformer model may generate the output based on processing sets of point data associated with multiple polar cells (e.g., two, three, all of the polar cells, and/or the like) within an angular subrange that includes the first polar cell. The transformer may identify a second polar cell within the angular subrange that includes the first polar cell based on the sequence. The transformer model may process point data associated with a set of data points associated with the second polar cell in a manner similar to that described above. In some aspects, the transformer model continues in a similar manner for each polar cell included in the angular subrange. The transformer model may generate the output based on processing the sets of point data associated with each polar cell included in the angular subrange.

In some aspects, the transformer model is configured to selectively determine whether to process a particular subset of point data associated with data points associated with a polar cell based at least in part on whether a polar cell associated with a previously processed subset of point data included at least one data point. For example, the transformer model may determine not to process a particular subset of point data based on a polar cell associated with a previously processed subset of point data not including at least one data point. In some aspects, the transformer model may generate the output based on determining not to process the particular subset of point data.

The lidar system may provide the output (e.g., the object information) to a vehicle associated with the lidar data. As shown in FIG. 4B, and by reference number 430, the ECU of the vehicle determines whether an object is indicated or identified based on the object data. The ECU may analyze the object data included in the output provided by the lidar system and may determine whether an object is indicated or identifying based on the analysis. The ECU may provide object information via a user interface associated with the vehicle and/or a driver of the vehicle (e.g., a user interface of a user device of the driver) and/or may control an operation of the vehicle (e.g., cause the vehicle to emit a notification (e.g., a sound and/or a light), stop, slow down, speed up, and/or change lanes, among other examples) when the object is indicated or identified.

As shown by reference number 440, the lidar scanner and the lidar system iterate for the next angular subrange. The transformer model may sequentially process sets of point data associated with data points in polar cells included in the remaining angular subranges in a similar manner based on processing data points included in each polar cell of the angular subrange and/or based on determining not to process a particular subset of point data. The transformer model may generate an output associated with the next angular range and may provide the output to the vehicle in a manner similar to that described above.

As shown by reference numbers 450 and 460, the ECU indicates object information via a user interface associated with the vehicle and/or controls the vehicle according to a location of the object. The ECU may cause object information to be displayed via a user interface associated with the vehicle and/or a driver of the vehicle and/or may control an operation of the vehicle based on the object information indicating and/or identifying the object, a type of the object, a location of the object relative to the vehicle, and/or an operating parameter associated with the vehicle (e.g., a speed of the vehicle, an acceleration of the vehicle, a current weather condition, a type of road (e.g., a paved road, a gravel road, a wet road, and/or an icy road, among other examples) being traveled by the vehicle, and/or another type of operating parameter).

As shown by reference number 470, the lidar system updates the transformer model according to feedback input via the user interface. The feedback may indicate an accuracy associated with the output. For example, a user may input information indicating whether the object was located at the location indicated by the object information, whether the object was the type of object indicated by the object information, whether an action performed by the ECU was appropriate, and/or other types of feedback information. The lidar system may utilize the feedback and the lidar scanner used to generate the output to retrain the transformer model. In this way, the lidar system may increase an accuracy of the outputs generated by the transformer model relative to a transformer model that is not retrained based on received feedback.

As indicated above, FIGS. 4A-4B are provided as an example. Other examples may differ from what is described with respect to FIGS. 4A-4B.

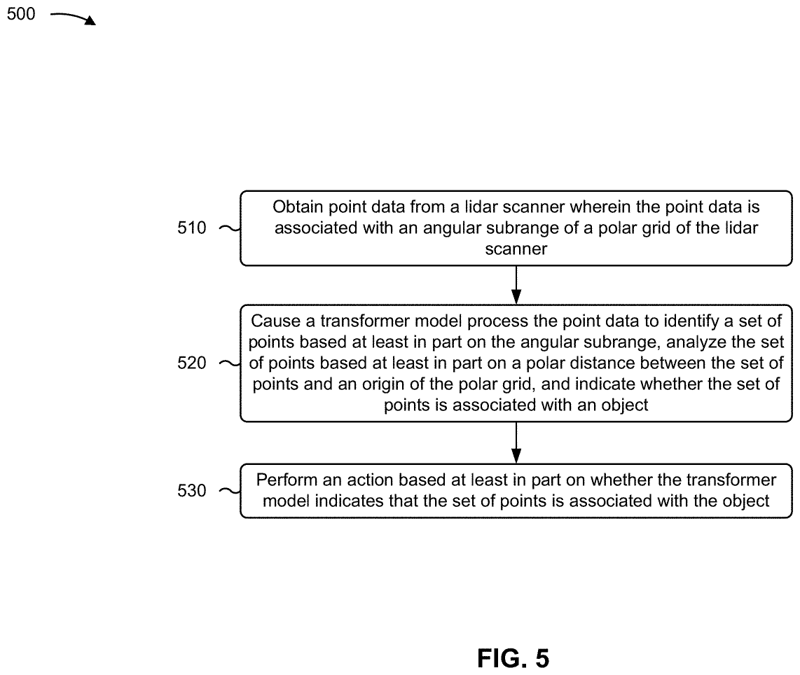

FIG. 5 is a flowchart of an example process 500 associated with object detection for a rotational sensor. In some implementations, one or more process blocks of FIG. 5 may be performed by a device (e.g., a lidar system). In some implementations, one or more process blocks of FIG. 5 may be performed by another device or a group of devices separate from or including the device, such as a vehicle (e.g., a vehicle 110 and/or an ECU 112) and/or a wireless communication device (e.g., a wireless communication device 120). Additionally, or alternatively, one or more process blocks of FIG. 5 may be performed by one or more components of device 200, such as the processor 210, the memory 215, the storage component 220, the input component 225, the output component 230, the communication interface 235, the sensor 240, and/or the lidar system 245.

As shown in FIG. 5, process 500 may include obtaining point data from a lidar scanner (block 510). For example, the device may obtain point data from a lidar scanner, as described above. In some implementations, the point data is associated with an angular subrange of a polar grid of the lidar scanner.

As further shown in FIG. 5, process 500 may include causing a transformer model to process the point data to identify a set of points based at least in part on the angular subrange, analyze the set of points based at least in part on a polar distance between the set of points and an origin of the polar grid, and indicate whether the set of points is associated with an object (block 520). For example, the device may cause a transformer model to process the point data to identify a set of points based at least in part on the angular subrange, analyze the set of points based at least in part on a polar distance between the set of points and an origin of the polar grid, and indicate whether the set of points is associated with an object, as described above.

As further shown in FIG. 5, process 500 may include performing an action based at least in part on whether the transformer model indicates that the set of points is associated with the object (block 530). For example, the device may perform an action based at least in part on whether the transformer model indicates that the set of points is associated with the object, as described above.

Process 500 may include additional implementations, such as any single implementation or any combination of implementations described below and/or in connection with one or more other processes described elsewhere herein.

In a first implementation, the transformer model is trained to determine whether the set of points is representative of the object based at least in part on historical data associated with another scanner that identified another object in an area that is a physical distance from the another scanner. The other object and the object may be a same type and the another scanner may be associated with the lidar scanner. The physical distance may be associated with the polar distance.

In a second implementation, the transformer model is trained to determine whether the set of points is representative of the object based at least in part on historical data associated with another object within a feature space that corresponds to a polar cell, of the polar grid, that is defined by the polar distance. The historical data may include one or more historical sets of points that are representative of the other object.

In a third implementation, the transformer model is trained to determine whether the set of points is representative of the object based at least in part on an arrangement of the set of points within a polar cell of the polar grid. The transformer model may be trained based at least in part on historical sets of points associated with another object within a feature space that corresponds to the polar cell.

In a fourth implementation, the transformer model comprises an encoder that translates polar coordinates of the set of points to object query data, and a decoder that predicts whether the set of points is associated with the object based at least in part on the object query data.

In a fifth implementation, the object query data comprises three dimensional data that is associated with one or more types of objects. The transformer model may be trained to identify the one or more types of objects and a type of the object may be one of the one or more types of objects.

In a sixth implementation, the decoder is configured to predict whether the set of points is associated with the object based at least in part on a similarity analysis associated with the object query data and reference data associated with the type of the object.

In a seventh implementation, the transformer model processes the point data based at least in part on a sequence associated with the polar grid. The sequence indicates an order in which individual subsets of the point data that are associated with corresponding polar cells of the polar grid are to be processed.

In an eighth implementation, the transformer model is configured to selectively determine whether to process a particular subset of the point data based at least in part on whether a previously processed subset of the point data included at least one point.

In a ninth implementation, performing the action comprises providing, via a user interface and based at least in part on the transformer model indicating that the set of points is associated with the object, an indication associated with the object. The indication may indicate at least one of a location of the object, or a type of the object.

In a tenth implementation, performing the action comprises obtaining, from a user device and based at least in part on the transformer model indicating that the set of points is not associated with the object, feedback associated with an indication that the set of points is not associated with the object, and retraining the transformer model based at least in part on the set of points and the feedback.

In an eleventh implementation, the angular subrange corresponds to a range that is a threshold percentage of 360 degrees.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The following provides an overview of some Aspects of the present disclosure:

Aspect 1: A method, comprising obtaining, by a device, point data from a lidar scanner, wherein the point data is associated with an angular subrange of a polar grid of the lidar scanner; causing, by the device, a transformer model to process the point data to identify a set of points based at least in part on the angular subrange, analyze the set of points based at least in part on a polar distance between the set of points and an origin of the polar grid, and indicate whether the set of points is associated with an object; and performing, by the device, an action based at least in part on whether the transformer model indicates that the set of points is associated with the object.

Aspect 2: The method of Aspect 1, wherein the transformer model is trained to determine whether the set of points is representative of the object based at least in part on historical data associated with another scanner that identified another object in an area that is a physical distance from the another scanner, wherein the other object and the object are a same type and the another scanner is associated with the lidar scanner, and wherein the physical distance is associated with the polar distance.

Aspect 3: The method of any of Aspects 1 through 2, wherein the transformer model is trained to determine whether the set of points is representative of the object based at least in part on historical data associated with another object within a feature space that corresponds to a polar cell, of the polar grid, that is defined by the polar distance, wherein the historical data includes one or more historical sets of points that are representative of the other object.

Aspect 4: The method of any of Aspects 1 through 3, wherein the transformer model is trained to determine whether the set of points is representative of the object based at least in part on an arrangement of the set of points within a polar cell of the polar grid, and wherein the transformer model is trained based at least in part on historical sets of points associated with another object within a feature space that corresponds to the polar cell.

Aspect 5: The method of any of Aspects 1 through 4, wherein the transformer model comprises: an encoder that translates polar coordinates of the set of points to object query data; and a decoder that predicts whether the set of points is associated with the object based at least in part on the object query data.

Aspect 6: The method of Aspect 5, wherein the object query data comprises three dimensional data that is associated with one or more types of objects, wherein the transformer model is trained to identify the one or more types of objects, and wherein a type of the object is one of the one or more types of objects.

Aspect 7: The method of Aspect 6, wherein the decoder is configured to predict whether the set of points is associated with the object based at least in part on a similarity analysis associated with the object query data and reference data associated with the type of the object.

Aspect 8: The method of any of Aspects 1 through 7, wherein the transformer model processes the point data based at least in part on a sequence associated with the polar grid, wherein the sequence indicates an order in which individual subsets of the point data that are associated with corresponding polar cells of the polar grid are to be processed.

Aspect 9: The method of Aspect 8, wherein the transformer model is configured to selectively determine whether to process a particular subset of the point data based at least in part on whether a previously processed subset of the point data included at least one point.

Aspect 10: The method of any of Aspects 1 through 9, wherein performing the action comprises: providing, via a user interface and based at least in part on the transformer model indicating that the set of points is associated with the object, an indication associated with the object, wherein the indication indicates at least one of: a location of the object, or a type of the object.

Aspect 11: The method of any of Aspects 1 through 10, wherein performing the action comprises: obtaining, from a user device and based at least in part on the transformer model indicating that the set of points is not associated with the object, feedback associated with an indication that the set of points is not associated with the object; and retraining the transformer model based at least in part on the set of points and the feedback.

Aspect 12: The method of any of Aspects 1 through 11, wherein the angular subrange corresponds to a range that is a threshold percentage of 360 degrees.

Aspect 13: An apparatus for wireless communication at a device, comprising a processor; memory coupled with the processor; and instructions stored in the memory and executable by the processor to cause the apparatus to perform the method of one or more Aspects of Aspects 1-12.

Aspect 14: A device for wireless communication, comprising a memory and one or more processors coupled to the memory, the memory and the one or more processors configured to perform the method of one or more Aspects of Aspects 1-12.

Aspect 15: An apparatus for wireless communication, comprising at least one means for performing the method of one or more Aspects of Aspects 1-12.

Aspect 16: A non-transitory computer-readable medium storing code for wireless communication, the code comprising instructions executable by a processor to perform the method of one or more Aspects of Aspects 1-12.

Aspect 17: A non-transitory computer-readable medium storing a set of instructions for wireless communication, the set of instructions comprising one or more instructions that, when executed by one or more processors of a device, cause the device to perform the method of one or more Aspects of Aspects 1-12.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
obtaining, by a device, point data from a lidar scanner,
wherein the point data is associated with an angular subrange of a polar grid of the lidar scanner;
causing, by the device, a transformer model to:
process the point data to identify a set of points based at least in part on the angular subrange,
analyze the set of points based at least in part on a polar distance between the set of points and an origin of the polar grid, and
indicate whether the set of points is associated with an object; and
performing, by the device, an action based at least in part on whether the transformer model indicates that the set of points is associated with the object.

2. The method of claim 1, wherein the transformer model is trained to determine whether the set of points is representative of the object based at least in part on historical data associated with another scanner that identified another object in an area that is a physical distance from the another scanner,
wherein the other object and the object are a same type and the other scanner is associated with the lidar scanner, and
wherein the physical distance is associated with the polar distance.

3. The method of claim 1, wherein the transformer model is trained to determine whether the set of points is representative of the object based at least in part on historical data associated with another object within a feature space that corresponds to a polar cell, of the polar grid, that is defined by the polar distance,
wherein the historical data includes one or more historical sets of points that are representative of the other object.

4. The method of claim 1, wherein the transformer model is trained to determine whether the set of points is representative of the object based at least in part on an arrangement of the set of points within a polar cell of the polar grid, and
wherein the transformer model is trained based at least in part on historical sets of points associated with another object within a feature space that corresponds to the polar cell.

5. The method of claim 1, wherein the transformer model comprises:
an encoder that translates polar coordinates of the set of points to object query data; and
a decoder that predicts whether the set of points is associated with the object based at least in part on the object query data.

6. The method of claim 5, wherein the object query data comprises three dimensional data that is associated with one or more types of objects,
wherein the transformer model is trained to identify the one or more types of objects, and
wherein a type of the object is one of the one or more types of objects.

7. The method of claim 6, wherein the decoder is configured to predict whether the set of points is associated with the object based at least in part on a similarity analysis associated with the object query data and reference data associated with the type of the object.

8. The method of claim 1, wherein the transformer model processes the point data based at least in part on a sequence associated with the polar grid,
wherein the sequence indicates an order in which individual subsets of the point data that are associated with corresponding polar cells of the polar grid are to be processed.

9. The method of claim 8, wherein the transformer model is configured to selectively determine whether to process a particular subset of the point data based at least in part on whether a previously processed subset of the point data included at least one point.

10. The method of claim 1, wherein performing the action comprises:
providing, via a user interface and based at least in part on the transformer model indicating that the set of points is associated with the object, an indication associated with the object,
wherein the indication indicates at least one of:
a location of the object, or
a type of the object.

11. The method of claim 1, wherein performing the action comprises:
obtaining, from a user device and based at least in part on the transformer model indicating that the set of points is not associated with the object, feedback associated with an indication that the set of points is not associated with the object; and
retraining the transformer model based at least in part on the set of points and the feedback.

12. The method of claim 1, wherein the angular subrange corresponds to a range that is a threshold percentage of 360 degrees.

13. A device, comprising:
one or more memories; and
one or more processors, communicatively coupled to the one or more memories, configured to:
obtain point data from a lidar scanner,
wherein the point data is associated with an angular subrange of a polar grid of the lidar scanner;
cause a transformer model to:
process the point data to identify a set of points based at least in part on the angular subrange,
analyze the set of points based at least in part on a polar distance between the set of points and an origin of the polar grid, and
indicate whether the set of points is associated with an object; and
perform an action based at least in part on whether the transformer model indicates that the set of points is associated with the object.

14. The device of claim 13, wherein the transformer model is trained to determine whether the set of points is representative of the object based at least in part on historical data associated with another scanner that identified another object in an area that is a physical distance from the other scanner,
wherein the other object is associated with the object and the other scanner is associated with the lidar scanner, and
wherein the physical distance is associated with the polar distance.

15. The device of claim 13, wherein the transformer model is trained to determine whether the set of points is representative of the object based at least in part on historical data associated with another object within a feature space that corresponds to a polar cell, of the polar grid, that is defined by the polar distance,
wherein the historical data includes one or more historical sets of points that are representative of the other object.

16. The device of claim 13, wherein the transformer model is trained to determine whether the set of points is representative of the object based at least in part on an arrangement of the set of points within a polar cell of the polar grid, and
wherein the transformer model is trained based at least in part on historical sets of points associated with another object within a feature space that corresponds to the polar cell.

17. The device of claim 13, wherein the transformer model comprises:
an encoder that translates polar coordinates of the set of points to object query data; and
a decoder that predicts whether the set of points is associated with the object based at least in part on the object query data.

18. The device of claim 13, wherein the one or more processors, to perform the action, are configured to:
provide, via a user interface and based at least in part on the transformer model indicating that the set of points is associated with the object, an indication associated with the object,
wherein the indication indicates at least one of:
a location of the object, or
a type of the object.

19. A non-transitory computer-readable medium storing a set of instructions, the set of instructions comprising:
one or more instructions that, when executed by one or more processors of a device, cause the device to:
obtain point data from a lidar scanner,
wherein the point data is associated with an angular subrange of a polar grid of the lidar scanner;
cause a transformer model to:
process the point data to identify a set of points based at least in part on the angular subrange,
analyze the set of points based at least in part on a polar distance between the set of points and an origin of the polar grid, and
indicate whether the set of points is associated with an object; and
perform an action based at least in part on whether the transformer model indicates that the set of points is associated with the object.

20. The non-transitory computer-readable medium of claim 19, wherein the transformer model is trained to determine whether the set of points is representative of the object based at least in part on historical data associated with another scanner that identified another object in an area that is a physical distance from the other scanner,
wherein the other object is associated with the object and the other scanner is associated with the lidar scanner, and
wherein the physical distance is associated with the polar distance.

21. The non-transitory computer-readable medium of claim 19, wherein the transformer model is trained to determine whether the set of points is representative of the object based at least in part on historical data associated with another object within a feature space that corresponds to a polar cell, of the polar grid, that is defined by the polar distance,
wherein the historical data includes one or more historical sets of points that are representative of the other object.

22. The non-transitory computer-readable medium of claim 19, wherein the transformer model is trained to determine whether the set of points is representative of the object based at least in part on an arrangement of the set of points within a polar cell of the polar grid, and
wherein the transformer model is trained based at least in part on historical sets of points associated with another object within a feature space that corresponds to the polar cell.

23. The non-transitory computer-readable medium of claim 19, wherein the transformer model comprises:
an encoder that translates polar coordinates of the set of points to object query data; and
a decoder that predicts whether the set of points is associated with the object based at least in part on the object query data.

24. The non-transitory computer-readable medium of claim 19, wherein the one or more instructions, that cause the device to perform the action, cause the device to:
provide, via a user interface and based at least in part on the transformer model indicating that the set of points is associated with the object, an indication associated with the object,
wherein the indication indicates at least one of:
a location of the object, or
a type of the object.

25. An apparatus, comprising:
means for obtaining point data from a lidar scanner,
wherein the point data is associated with an angular subrange of a polar grid of the lidar scanner;
means for causing a transformer model to:
process the point data to identify a set of points based at least in part on the angular subrange,
analyze the set of points based at least in part on a polar distance between the set of points and an origin of the polar grid, and
indicate whether the set of points is associated with an object; and
means for performing an action based at least in part on whether the transformer model indicates that the set of points is associated with the object.

26. The apparatus of claim 25, wherein the transformer model is trained to determine whether the set of points is representative of the object based at least in part on historical data associated with another scanner that identified another object in an area that is a physical distance from the other scanner,
wherein the other object is associated with the object and the other scanner is associated with the lidar scanner, and
wherein the physical distance is associated with the polar distance.

27. The apparatus of claim 25, wherein the transformer model is trained to determine whether the set of points is representative of the object based at least in part on historical data associated with another object within a feature space that corresponds to a polar cell, of the polar grid, that is defined by the polar distance,
wherein the historical data includes one or more historical sets of points that are representative of the other object.

28. The apparatus of claim 25, wherein the transformer model is trained to determine whether the set of points is representative of the object based at least in part on an arrangement of the set of points within a polar cell of the polar grid, and
wherein the transformer model is trained based at least in part on historical sets of points associated with another object within a feature space that corresponds to the polar cell.

29. The apparatus of claim 25, wherein the transformer model comprises:
an encoder that translates polar coordinates of the set of points to object query data; and
a decoder that predicts whether the set of points is associated with the object based at least in part on the object query data.

30. The apparatus of claim 25, wherein the means for performing the action comprises:
means for providing, via a user interface and based at least in part on the transformer model indicating that the set of points is associated with the object, an indication associated with the object,
wherein the indication indicates at least one of:
a location of the object, or
a type of the object.
